(19) United States
(12) Patent Application Publication
(10) Pub. No.: US 2026/0042373 A1
(43) Pub. Date: Feb. 12, 2026

(54) ENHANCED ELECTRIC VEHICLE IDENTIFICATION FOR IMPROVED CHARGING

(71) Applicant: dcbel Inc., Montréal (CA)

(72) Inventors: Ernest Montllo Casabayo, Montréal (CA); Jean-Hugues Deschênes, Montréal (CA); Vinh Nguyen, Brossard (CA)

(21) Appl. No.: 19/271,253

(22) Filed: Jul. 16, 2025

Related U.S. Application Data
(60) Provisional application No. 63/679,892, filed on Aug. 6, 2024.

(51) Int. Cl. B60L 53/65; B60L 53/16; B60L 53/66

(52) U.S. Cl. CPC B60L 53/65; B60L 53/16; B60L 53/66

(57) ABSTRACT

Distinguishing each electric vehicle (EV) connected to an electric vehicle supply equipment (EVSE) is based on additional vehicle-specific information, thereby enhancing the accuracy of the distinguishing or identification of the connected EV thereby allowing for a better quality of the service (e.g., charging or discharging) provided by the EVSE. Recognizing distinguishing information can be used to gather EV-specific statistics and specifications to provide and improve tailored charging experience of the EV's owner based on the recognized/identified known EV and optional EV owner preferences by distinguishing any connected EV from other EVs.

### CROSS-REFERENCE TO RELATED APPLICATIONS

This application claims priority from U.S. Provisional Patent Application 63/679,892 filed Aug. 6, 2025, incorporated herein by reference.

### TECHNICAL FIELD

This document relates to electric vehicles, namely the managing protocol of electric vehicle chargers.

### BACKGROUND

More than 10 million electric vehicles (EV) are sold every year and a significant portion of the EV owner have equipped their residence with an electric current converter or electric vehicle supply equipment (EVSE) commonly referred to as an EVSE. With a significant growth of the EV market share, it is now quite common to see the EVSEs being used to manage the charging of more than one EV consecutively or simultaneously. It is now common to see a household being that needs to charge more than one EV, possibly through the same EVSE.

While next generation protocols are set to be using an EVCC ID field (proposed by the CCS family: the DIN 70121 standard that specifies the requirements for the communication protocol for DC charging and communication with the supply system or the ISO 15118 standard that defines a high-level communication protocol for EVs and charging stations to charge/discharge the EV's high-voltage battery) to uniquely identify EVs, this proposed method of identification lacks vehicle-specific details and acts as a mere identification tag.

Some state-of-the-art protocols do not provide enough information about the EV's vehicle-specific specifications and characteristics to formally identify an EV, or identify an EV with a satisfying certainty. Some chargers mainly rely on informal information, which may lead to inaccurate identification, confusion (distinguishing two vehicles as being the same) and may be tricked in identifying a new or unknown or unauthorized EV as a known EV. While each vehicle has an identification number (VIN), current EVs do not communicate their VIN to the charger.

Furthermore, some vehicle specific charging protocol provided by some state-of-the-art EV chargers rely on the vehicle's MAC address (e.g., 6 to 8 bytes) of the electric vehicle, which is considered to be a unique EV identifier (ID) that links each EV to a specific customer account to defining a corresponding charging protocol, but this method is not always reliable some of the MAC addresses are duplicated by some car manufacturer since there is no standard for ensuring that each MAC address is truly unique.

Therefore, when the EV ID is not provided to the charger or when the MAC address is a duplicate and/or when vehicle-specific details are desirable or required, there is a need to accurately distinguishing a specific EV from others in the absence of a unique

EV ID or provide vehicle-specific information when a unique EV ID is provided. It would be useful as a reliable way of improving security of the EVSE by preventing possible electricity theft (e.g., by a possibly mischievous neighbor) and to ensure accurate adapted charging services when the charger provides EV-based charging protocols.

There is a need to improve the registration process of a new EV profile, whether the VID is provided, or not, by the EV since the unique EV ID does not generally provide details about the make and model of the EV.

There is a need to develop a method or apparatus to improve the accurate distinguishing or identification by the EVSE of a specific EV from other EVs.

### SUMMARY

The present disclosure relates to methods and systems for distinguishing each EV connected to an EVSE based on additional vehicle-specific information, thereby enhancing the accuracy of the distinguishing (e.g., identification) of the connected EV connected thereby allowing for a better quality of the service (e.g., charging or discharging) provided by the EVSE. Recognizing distinguishing information can be used to gather EV-specific statistics and specifications to provide and improve tailored charging experience of the EV's owner based on the recognized/identified known EV and optional EV owner preferences by distinguishing any connected EV from other EVs.

Additionally, the proposed methods and systems can be used to provide added range estimates, charge & discharge time estimates, monitor the amount of charge/discharge cycles, etc. In some embodiments, it is possible to lock out possible energy thieves (or only allow discharging) by defining a new or unknown EV.

Another aspect of the proposed method and systems may provide significantly improved user experience by facilitating and expediting the registration process of a new EV profile, whether the unique EV ID is provided or not. In some embodiments, this registration process may be improved by pre-filing the various fields of the new profile and by providing a drop-down list with a subset of choices for each given profile fields, thereby significantly improving the user experience when creating a new know EV profile.

A broad aspect of the present disclosure is an electric vehicle supply equipment (EVSE) for distinguishing an EV connected to the EVSE, the device comprising: I) an EV charging interface for charging the EV; II) a communication interface for receiving messages from the EV; III) power converter circuitry; IV) a processor; and V) memory storing program code that, when executed by the processor, causes the processor to: a) establish a connection with the EV once the EV charging interface is connected to the EV; b) receive a plurality of the messages from the EV; c) select distinguishing information from the plurality of messages; and d) determine at least one of: 1) which known-EV is connected using the selected distinguishing information in the absence of a unique EV identifier (ID) being provided for the purposes of at least one of: i) establishing if the EV is authorized for charging; ii) maintaining a history of charging the EV; and iii) initiating a charging protocol associate with the determined known EV; 3) at least a subset of the vehicle's makes and models from the distinguishing information for the purpose of guiding a user in selecting an actual make and model of the vehicle; and 4) a distinguishing signature of an unknown EV using the selected distinguishing information in the absence of a unique EV identifier (ID) being provided for the purpose of recognizing the unknown EV when a next connection is established between the EVSE.

In some embodiments, the determining comprises, in the absence of the unique EV ID, the determining of which of the known EV is connected using the selected distinguishing information for the purposes of the establishing if the EV is authorized for charging.

In some embodiments, the determining comprises, in the absence of the unique EV ID, the determining of which of the known EV is connected using the selected distinguishing information for the purposes of the maintaining the history of charging the EV.

In some embodiments, the determining comprises, in the absence of the unique EV ID, the determining of which of the known EV is connected using the selected distinguishing information for the purposes of the initiating the charging protocol of associate with the determined known EV.

In some embodiments, the charging messages from the EV comprises the unique EV ID, wherein the program code, when executed by the processor, further causes the processor to identify the EV using the unique EV ID, and wherein the distinguishing information, and wherein the subset of vehicle makes and models are identified from the distinguishing information for the guiding of the user in the selecting the actual make and model of the vehicle.

In some embodiments, the unique EV ID a media access control (MAC) address of the EV or a vehicle identification number (VIN).

In some embodiments, the determining comprises, in the absence of the unique EV ID, the determining of the distinguishing signature of the unknown EV using the selected distinguishing information for the purpose of recognizing the unknown EV when a next connection is established between the EVSE, thereby allowing for a initiating of a corresponding history of charging, for initiating of a corresponding charging protocol, or for establishing charging is authorized.

In some embodiments, the determining further comprises defining parameters of the corresponding charging protocol based on charging directives from an instruction provider.

In some embodiments, the parameters of the corresponding charging protocol are provided in response to an intervention request requesting the charging directives, wherein the communication interface sends the intervention request to a personal device of the instruction provider, and wherein the charging directives from the instruction provider are received by the communication interface.

In some embodiments, the intervention request further comprises: educated guesses about the EV characteristics based on the distinguishing information, and a request for the instruction provider to validate the educated guesses or to correct the educated guesses by indicating an actual information.

In some embodiments, the EV characteristics comprise makes and models of the known EV.

In some embodiments, the EV charging interface and the communication interface are comprised in a charging connector of the EVSE.

In some embodiments, the charging connector comprises a CHAdeMO plug for connecting to a CHAdeMO socket of the EV, wherein the charging protocol is a CHAdeMO protocol, and wherein the at least one distinguishing information and the various distinguishing information comprise CHAdeMO fields.

In some embodiments, the collection of data from the various distinguishing information comprises a hash value.

In some embodiments, the collection of data from the various distinguishing information comprises a Boolean value.

In some embodiments, the power converter circuitry is a bidirectional power converter circuitry, and wherein the charging protocol allows for both the charging and the discharging of the EV.

In some embodiments, if the EV is an unknown EV, the program code, when executed by the processor, further causes the processor to limit the charging or the discharging of the unknown EV until the parameters of the corresponding charging protocol defined.

In some embodiments, the limiting of the charging protocol comprises preventing any charging or the discharging of the unknown EV.

In some embodiments, the program code, when executed by the processor, further causes the processor to detect a presence of the EV near the EVSE.

In some embodiments, the program code, when executed by the processor, further causes the processor to save the determined distinguishing signature in a collection of known distinguishing signatures as a known distinguishing signature.

Another broad aspect is a method for distinguishing an EV connected to a vehicle supply equipment (EVSE), the method comprising the steps described above with reference to the program code executed by the processor.

### BRIEF DESCRIPTION OF THE DRAWINGS

The invention will be better understood by way of the following detailed description of embodiments of the invention with reference to the appended drawings, in which:

FIG. 1 shows a block diagram of one embodiment of a system comprising an electric vehicle charger connected an electric vehicle to receive the EV distinguishing data.

FIG. 2 shows a flowchart of an embodiment of a distinguishing method for recognizing a known EV or for determining that the EV is unknown.

FIG. 3A shows a block diagram of the various steps that may be completed to have an intervention executed.

FIG. 3B shows a block diagram of one embodiment of the steps that may be completed by the instruction provider's device in order to acquire the instructions and information to fulfill the requested intervention.

FIG. 4 shows a block diagram of the hardware components of one embodiment of the EVSE.

FIG. 5 shows a block diagram of embodiments of the EVSE using the distinguishing information extracted from the charge messages exchanged between the EVSE and the EV.

FIG. 6 shows a flowchart of a possible embodiment of the proposed method.

### DETAILED DESCRIPTION

Unless the context requires otherwise, throughout the specification and claims which follow, the word “comprise” and variations thereof, such as “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

From the foregoing it will be appreciated that, although specific embodiments have been described herein for purposes of illustration, various modifications may be made without deviating from the spirit and scope of the teachings. Accordingly, the claims are not limited by the disclosed embodiments.

The following is a detailed description of embodiments of the disclosure depicted in the accompanying drawings. The embodiments are in such detail as to clearly communicate the disclosure without limiting the anticipated variations of the possible embodiments and may encompass all modifications, equivalents, combinations and alternatives falling within the spirit and scope of the present disclosure. It will be appreciated by those skilled in the art that well-known methods, procedures, physical processes and components may not have been described in detail in the following so as not to obscure the specific details of the disclosed embodiments.

In the present disclosure, vocabulary such as recharging or charging is intended to also, optionally, apply to and include both recharging and discharging when possible and where the person skilled in the art would find it appropriate to do so. Also, when the referring to the “connection” between an EV and an EVSE or to a “connected EV”, it will be appreciated that the nature of the connection may not be limited to a physical connection such as through connectors, cables or wires and may be considered as encompassing a wireless connection established for wireless charging.

It will be appreciated by the person skilled in the art that while the exemplary embodiments of the apparatus and method proposed herein may be described or presented in a software or hardware or a combination thereof for purposes of illustration and so as not to obscure the specific details of the disclosed invention, the various components of the proposed apparatus and the various steps of the proposed method may be implemented in the software (i.e., program code storing instructions that can be executed by a processor) or hardware (e.g., electronic or mechanical components) using any suitable means and knowledge available in the state of the art and as the person skilled in the art would see fit.

A vehicle specific identifier or signature, e.g., such as a vehicle distinguishing signature (DS), presents a useful and reliable way of defining or configuring various EV's profiles (e.g., building an EV profile database on a given EVSE or shared across devices) which can be used to better monitor and/or control the usage or the charging/discharging of the corresponding EV. Furthermore, using a DS represents a significantly reliable solution to misidentification of an EV by the EVSE, which in the state of the art can confuse one EV with another (e.g., a similar or same model or brand). In fact, it may be possible to use known DS of various known EVs (i.e., EVs that were previously connected to the EVSE) to recognize a known EV reliably and accurately. The DS can allow to distinguish from a low number of possible vehicles (the owners, his guests, or a possible energy thief) up to a significant number of EVs.

It will be appreciated that, in some embodiments, the distinguishing signature (DS) can be obtained from the usual exchange of charging messages that do not provide an identification of the make and model of the EV to provide a collection of one or more distinguishing pieces of information about an EV or a single, or a combination of, an identifier (e.g., string of bits or sequence of numbers/letters) that may be based on a collection of one or more pieces of distinguishing information 111.

The EVSE can use or generate a unique signature for each EV that may be based on or built with the EV's DS that can comprise information about the software or, preferably, the hardware (e.g., EV known range of allowed values for target battery voltage) of an electric vehicle (EV), e.g., make and model.

In some embodiments, the signature of an EVSE may be built using information/data exchange with an external device, which may be accessible or used by the EV or EVSE owner.

The DS may be defined or built using a plurality of various distinguishing pieces of information (vehicle-specific information) about the one or more EVs connected to the EVSE. The amount/number of pieces of distinguishing information 111 may be predetermined, fixed or selectively adjusted by the EVSE. It will be appreciated that the more pieces of distinguishing information 111 are used to define a UIS, the higher the degree of confidence the EVSE may have the identified/recognized EV is indeed the one corresponding to the matched DS and not another similar EV.

In fact, using a single distinguishing piece of information would result in a significantly high probability that another EV can provide the EVSE with the same information/value, thereby preventing any distinguishing between this other EV and the known EV. For example, an EVSE using the maximum battery capacity of an EV as its DS would not likely be able to distinguish between EVs having a same maximum battery capacity. Therefore, such an EVSE would have a low distinguishing confidence level and therefore of security that would strictly depend on the probability of encountering two EVs with the same, or undistinguishable, distinguishing information 111 (e.g., the maximum battery capacity in the previous example).

Note that the distinguishing confidence level is inversely proportional to the probability that the DS of a given/individual/distinct EV matches/corresponds to the DS of any other EV. Therefore, the highest distinguishing confidence level corresponds to a theoretical certainty that no other EV has the same UIS, while the lowest inversely proportional would correspond to a DS shared by all EVs.

One of the advantages of the proposed method is the improvement of this distinguishing confidence level, which may be achieved by increasing the number of pieces of distinguishing information 111 considered by the EVSE as constituting a DS resulting in an increasingly higher distinguishing confidence level.

While the EV's distinguishing information 111 (or simply identifying information) used for the DS may vary over time, distinguishing information 111 that rarely changes or remains unchanged are preferable. A preferred embodiment of a DS comprises a plurality of distinguishing information 111 that remains unchanged over the lifespan of the EV.

In fact, adding distinguishing information 111 to the DS can result in a reduction of the probability that the DS is the same for another EV (i.e., increasing the distinguishing confidence level) since each added distinguishing information 111 reduces this probability.

This can allow to better distinguish between various car make and model (e.g., brands, car models, year of manufacturing, battery capacity, etc.) and/or between a plurality of known EV profiles (that may comprise EV-specific charging protocol, charge history, user preferences and habits, a user information or credentials, etc.).

To acquire distinguishing information 111, a step of extracting the distinguishing information 111 from data received from the EV (e.g., charging messages) may be completed/executed using any suitable means (e.g., an algorithm/program code executed by a processor), which can comprise, but may not be limited to, the data processing steps of intercepting, sorting, extracting, selecting, identifying, classifying, translating, recreating, etc.

In some embodiments, the distinguishing information to define or build the DS may comprise any CRC32 of selected data fields and other information.

The distinguishing information 111 can include one or more fields of the computed hash values, which may be EV and charge protocol agnostic.

In some embodiments, the hash values can include any protocol types known and used in the art, such as CHAdeMO protocols (e.g., CHAdeMO 0.9 through 2.2) or DINspec protocols (e.g., DINspec 70121, iso 15118-2 or iso 15118-20).

In some embodiments, the hash values can include some of the fields of a CHAdeMO protocol that may include a max battery voltage (e.g., H. 100.4 or H. 100.5fields); a total capacity of traction battery (e.g., H.100.5 or H.100.6 fields); a CHADEMO protocol number (e.g., H.102.0 field); Target battery voltage (H.102.1, H.102.2 fields); and/or all fields (e.g., H110 field, H.700 field, and H.201.0).

The hash values can include various fields such as an EV ethernet frame MAC address, Supported App Protocol Req (all fields), Session Setup Req (all fields), Charge Parameter Discovery Req (EV Requested Energy Transfer Type), and/or Current Demand Req (EV Target Voltage).

The computed hash can be CRC32, MD5, SHA1, SHA256 or any other suitable algorithm capable of building a unique number from a collection of data points.

It will be appreciated by the person skilled in the art that the aforementioned fields are limited to only a few examples of the possible fields and can be extended as needed by any embodiment herein. Additionally, the actual presence of fields and/or messages can be tested for and the Boolean value representing its presence or absence is included in the hash.

For example, empiric values may be considered as the UIS, such as various response times (e.g., inter-message timings).

The selection of data fields can, however, be charge-protocol specific and may preferably comprise information from fields that are known not to vary over time and across EV firmware updates, thereby ensuring that the signature can remain reliable for EV recognition.

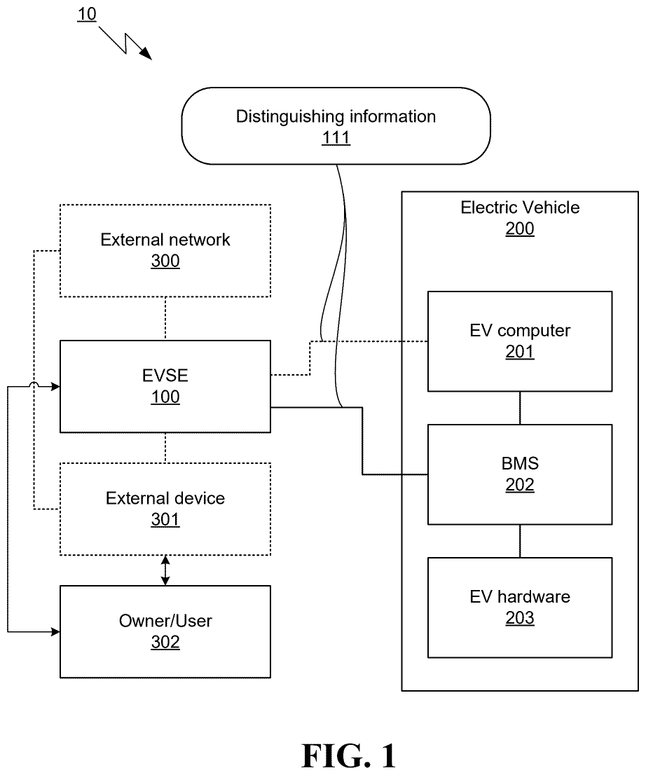

FIG. 1 presents a block diagram of one possible embodiment of a system 10 comprising an EVSE 100 (e.g., an EV charger) connected with an EV 200 (e.g., comprising an EV computer 201, a battery management system (BSM) 202, EV hardware 203). This system may be used to recognize a known EV accurately and reliably or identify an unknown/new EV to provide an adjusted or personalized charging service or protocol.

The proposed systems may be used for distinguishing an EV 200 when it is connected, via electric vehicle supply equipment, to an EVSE 100 based on distinguishing information 111. The distinguishing information 111 can be any suitable information that relates to the characteristics of the connected EV. The distinguishing information 111 may be found or selected from any data or information comprised in messages/signals exchanged between the BMS 202 and the EVSE 100. In some embodiments, the EVSE 100 can extract/interpret or simply receive the information comprised in the exchanged data (e.g., messages send by the BMS and received by the EVSE) before combing through all the information provided by the EV (e.g., by the BMS) to select or identify any of the useful or required distinguishing information 111.

It will be appreciated that, in some cases, the EV may not provide the EVSE with any information that may be considered a unique EV identifier (ID) by itself, while, in some cases, the EVSE may be provided with such a unique EV ID (e.g., the VIN or the MAC address of the EV). The unique EV ID, if any, may be considered as part of the distinguishing information 111 or as a separate or complementary information.

In the embodiments where the EV does communicate any of his unique EV ID, the EVSE may use any useful information (e.g., vehicle or battery wear, battery size, make and model, etc.) from the distinguishing information 111 in addition to the unique EV ID to better characterize the EV and its corresponding profile (i.e., information regarding a specific EV stored in the EVSE database).

The distinguishing information 111 (or the corresponding/associated EV profile or charging profile) can be used to adjust and/or enhancing the quality, accuracy and security of EV charging service(s) of provided by the EVSE 100. Recognizing vehicle-specific information can comprise using and/or gathering EV-specific statistics and specifications, which may be used to provide and improve tailored charging experience/service/protocol based on the recognized/identified known EV.

In some embodiments, the charging protocol provided by the EVSE 100 may be configured/tailored based on various settings, which may be, but are not limited to; the type of charging/discharging (fast/slow or wired/wireless), EV user's preferences/habits/etc., EV owner preferences/habits/etc., external conditions (e.g., electricity prices, environmental conditions—e.g., temperature or time of day-, day of the week or weekends) or a combination thereof.

The EVSE 100 may comprise a communication interface (e.g., wire, wireless, ethernet, Wi-Fi, Bluetooth®, etc.) that may allow for information/data (e.g., intervention or instruction request) exchange with an external device 301 (e.g., the interface or device that may be used by any owner or user 302 to interact with the EVSE 100 in order to receive or provide information), which may be accessible or used by the EV 200 or the EVSE 100 owner to provide the EVSE with their desired settings (e.g., charging protocols preferences) or complementary information (e.g., mark, model, vehicle wear, other preferences).

In some embodiments, the external device 301 may be any computing device accessible by any required owner or user 302. For example, the external device 301 can be a company computer connected to the external network 300 or a mobile device (e.g., smartphone) of a user 302. The user 302 may provide the EVSE 100 with any of its personal distinguishing information (name, employee number, car model, license plate number, etc.) via the external interface 301 or, of course, through an onboard user interface of the EVSE 100 for embodiments comprising such onboard interface.

It will be appreciated that the complementary information that can be provided by the EV owner or user 200 may be preceded or accompanied by the access data (e.g., user or owner's access credentials or personal information/identifier) which may be used or required to allow access (e.g., login) to control or settings of the EVSE 100. In some embodiments, the access status selected by the EV owner can be saved by the EVSE 100 and may be associated with the detection of the DS of the EV 200 so that, upon detection of the DS by the EVSE 100, the corresponding access is granted or that the corresponding charging protocol is initiated.

The communication interface of the EVSE 100 may be alternatively or further configured to exchange information/data with an external network 300 or external device that may be connected to a database or management system.

The external network 300 may be part of a system for sharing or monitoring information acquired or generated by the EVSE 100, which may be useful to connect or incorporate the EVSE 100 in a smart environment (i.e., a system of devices for coordinating, provide services, and control complicated information-e.g., smart home-) or a management system of an EV charging provider/manufacturer, for example.

In some embodiments, the EVSE 100 can communicate with an external network 300 (e.g., a network interconnecting a plurality of local or remote charging EVSEs) to exchange (upload/download) data with a central/remote database (e.g., a DS database of a network of EVSEs of a particular company or manufacturer). In such cases, the EVSE 100 may access a DS database on the external network 300 to use a list of known-DS (e.g., a DS database corresponding to a single entity, such as an employee DS database for EVs of employees of a company having offices at a plurality of locations) when trying to identify a connected EV 200 (e.g., matching the connected EV's DS or distinguishing information 111 with any known-UIS). Such embodiments can also share the external network 300 (e.g., upload to a DS database) any new DS that may be generated by the EVSE 100.

The EVSE 100 can be configured to enable communication with the EV 200 though through any suitable means (e.g., the charging cable), such that the information (e.g., the EV distinguishing information 111 used to build the UIS) can be sent by the EV computer 201 and/or BMS 202 of the connected EV 200. In one embodiment, the distinguishing information 111 can include information about the EV hardware 203 (such as battery information).

Additionally, the proposed methods and systems can be used to provide added range estimates, charge and discharge time estimates, monitor the number of charge/discharge cycles, etc. In some embodiments, it is possible to lock out possible energy thieves (or only allow discharging) by distinguishing a new or unknown EV.

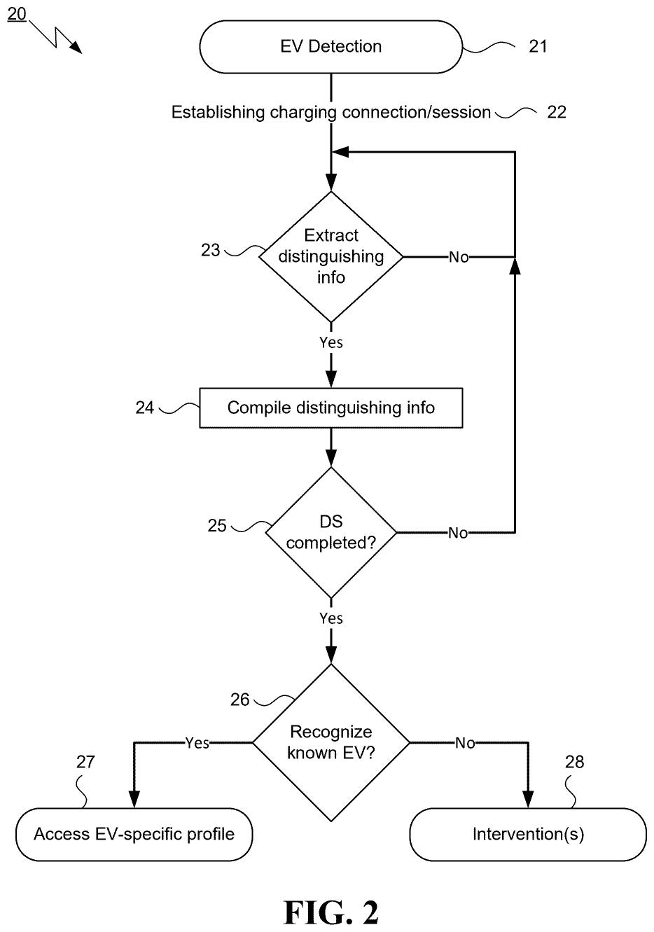

FIG. 2 presents a flowchart of a possible embodiment of a method 20 for accurately and reliably recognizing a known EV using distinguishing data/credentials. The various steps illustrated in this flowchart are only some of the possible steps that may be completed to ensure proper distinguishing (e.g., identification) of the EV.

In one embodiment of the recognizing/distinguishing method 20, the method is initiated after detecting the presence of a connected EV, which may be achieved using any suitable detection step 21. The detection step 21 may rely on various devices and technologies that can rely on mechanical interactions (activating a switch, pushing a button, proximity detection, connection detection, triggering of presence detection of a wireless charger, etc.) and/or electromagnetic interactions (e.g., proximity sensor, remote controller, Wi-Fi, Bluetooth®, radio signals, infrared camera, reception of any other electromagnetic signals) between the EV charger and the EV. The detection step 21 may further comprise any authentication scheme or process known in the art. In a preferred embodiment, the EV 200 is detected by the charging connection/interface of the EVSE (e.g., EV charging pistol/gun) upon connection to the charging connector of the EV. In some embodiments, the detection step 21 can rely on a proximity detector/switch to detect that the EVSE has been connected to the EV or is present and in position over the wireless charging pad of a wireless charger.

In step 22, a charging connection or session may be established. The charging connection may be established and allow for any exchange of data/information via electronic signals (e.g., through the charging cable) between the EVSE 100 and the EV 200 (e.g., BMS 202.

In some embodiments, the EVSE 100 can receive various distinguishing information 111 automatically sent by the EV 200 (e.g., from the BMS 202 or the computer 201).

In some embodiments, the exchange of data/information, the step may require the EVSE 100 to send one or more challenges (pings) to the EV 200 (e.g., the EV BMS 202 or the EV onboard computer 201) in order to receiving the required data/information.

The EVSE 100 can receive (and may request) one at a time or simultaneously a plurality of distinguishing information 111 from the EV 200 (e.g., from the BMS 202 or the computer 201).

The presence may be tested for and the distinguishing information 111 may comprise various protocol fields, such as the entire message of one or more of the H.200, H.700, H.110 fields or valid CAN messages (other than the H. 10xx, H.2xx or H.700) of the CHAdeMO 9.0 through 2.2 and/or the ChargeParameterDiscoveryReq (all optional fields) or the CableCheckReq (all optional fields) of the DINspec 70121, iso 15118-2 and iso 15118-20 protocols.

An information extraction step 23 may be completed to determine, identify and/or extract any distinguishing information 111 (information about the connected EV) from the received data (e.g., charging messages). If it is determined that the received data does not include any or all the required/expected distinguishing information 111, the EVSE 100 can “listen” to the EV 200 for further data exchanges that may comprise any further distinguishing information 111. When it is determined that the received data does include any distinguishing information 111, the identified distinguishing information 111 can be isolated/extracted from any other received data to be further processed (e.g., used for the following step 24). This information extraction step may be repeated as many times as required.

A step 24 of compiling the extracted distinguishing information 111 (e.g., saving in memory and/or creating/updating a temporary DS for the connected EV 200). In some embodiments, when the temporary DS is not yet created, step 24 can comprise initiating/generating a new temporary DS (e.g., new hash) specific to the recently connected EV 200 using the distinguishing information 111. Alternatively, when the sequence of steps is such that a temporary DS is already created (pending), the further distinguishing information 111 is used to update the temporary UIS. It will be appreciated that, in some embodiments, identify information 111 can be processed as hash values so that the creating of a new temporary DS involves creating a temporary ash value(s) and/or so that updating existing temporary DS involves using the hash values of the identify information to update existing temporary hash value(s).

It will be appreciated that, in embodiments where the DS is characterized by Boolean values (e.g., “true” or “false” values), step 24 can simply comprise uploading a corresponding Boolean criteria list (checkboxes) and using the distinguishing information 111 to determine which of the criteria from the criteria list are met (e.g., changing the Boolean value to “true”).

It will be appreciated temporary DS (temporary UIS) may be used solely for the purpose of matching there recently connected EV to an existing UIS, thereby distinguishing the connected vehicle as being one of the known EV and then discarding the temporary UIS. However in some cases, the temporary DS might further be used to register a new recognized EV by saving or storing a copy of said temporary DS as a known (e.g., authorized) DS in a corresponding database (e.g., the internal database of the EVSE 100 and/or a remote database of an external network 300).

A verification step 25 may be completed in order to verify if the compiled distinguishing information 111 is sufficient and ready to be compared to the known distinguishing information 111 or if it is incomplete, which may require some of the previous steps to be repeated until the verification step 25 is satisfied. In the illustrated exemplary embodiment, this verification step 25 can be completed to validate that the received data comprises each one of the pieces of distinguishing information 111 needed to build the temporary DS based on the information comprised in the known-DS (i.e., the more distinguishing information 111 is used to generate the known-UIS, the more distinguishing information 111 is required to satisfy this verification step).

Once the temporary DS (e.g., a plurality of pieces of distinguishing information or) is deemed completed, the EVSE 100 can determine if it matches any of the known-DS (step 26). The DS can be matched when the hash value(s) of the temporary DS matches the hash value(s) of the known-UIS. The DS can be matched when all of the Boolean criteria are met or when the Boolean values are “true”.

Note that, when no match is found, the EVSE 100 may optionally fetch additional known-DS (e.g., from an external network 300) before repeating step 26 using these additional known-UIS.

When a match is found, a step 27 of accessing (i.e., accessing, fetching, selecting, uploading, etc.) an EV-specific profile (e.g., charging profile or charging protocol) can be completed. The EV-specific profile may be accessed from locally stored in memory 101, from a shared database or a combination thereof. Once accessed, the various pieces of information about the recognized, distinguished or identified EV can be used as required. In some embodiments, the accessed EV-specific profile can be used to determine if the EV is authorized for charging or not, to access or update/maintain a history of charging of the EV (e.g., various parameters/statistics of the charging or discharging being applied, such as the time of charging, the duration of charging, value or type of current/voltage applied, the state of charge of the EV battery, battery wear, battery warranty update, etc.), to apply a corresponding charging protocol, or a combination thereof.

In some embodiments of step 27, the EV profile can comprise a corresponding charging protocol that can be executed/applied by the EVSE, which may be, but is not limited to, any one of: an AC charging; a fast DC charging; an intelligent charging (e.g., adaptative selection of charging or discharging according to a prioritized sequence, which may be based on various parameters as a household electricity consumption/demand, electricity rates $, needs for using the EV, etc.—see the international publication WO2019/071359A1 for example based on a prediction of the greatest probable jump of power drawn); a discharging; a manually selected charging mode; a vehicle-specific charging protocol (i.e., a charging protocol specially tailored for a specific EV); a voluntary pausing or delaying or preventing of the charging/discharging; or a combination thereof.

In some embodiments, the EV profile accessed on step 27 may be used to apply an intelligent charging, which may be for example an adaptative charging, where the various parameters of the charging may be changed/modulated during the charging and/or discharging process according to various variables.

The intelligent/adaptative charging may consider a local electricity production capacity (e.g., from photovoltaic cells or a windmill or from any other electricity generator), the present or future/expected (e.g., based on historical consumption data, which may be based on the time of day, on the season, on the day of the week, the number of occupants, the number and type of appliances, the size of the household, etc.—any type of information/parameters that may allow for better estimation of any future/expected needs) electricity needs of a household, the state of charge of the vehicle, the future/expected state of charge needs (e.g., a requirement of the EV owner to have his vehicle charged only overnight or to have the state of charge of the EV over a chosen threshold within a given charging time or by a selected hour of the day), the varying electricity rates (e.g., in a region where the price of electricity varies as a function of overall consumption on the electric grid or as a function of the time of day or as a function of seasons), a changing of the instructions from the EV or EVSE owner (e.g., when new instructions/preferences are provided by the instruction provider, etc. The intelligent charging may be particularly advantageous to reduce the electricity bill (e.g., by charging the EV when the electricity rates are at their lowest—overnight, for example) or to provide an improved user experience, for example, by providing “hands-free” charging management or by ensuring that the EV is always ready to be used (or keeps a state of charge that would allow for a chosen minimum distance threshold, such as “enough to go to work” or “enough to go to the nearest hospital” or “enough to go to the grocery store” or “enough to go to the sports practice”, etc.) which may be selected/adjusted by the instruction provider. In some cases the intelligent charging may communicate with the instruction provider (e.g., EVSE or EV owner), e.g., by sending intervention requests, to validate some of the various parameters it may consider for its decision making for the provided charging (e.g., asking if the EV is expected to be used for a next period of time-the next hours for example-).

It will be appreciated that the intelligent or adaptative charging may be used for dynamically modulate/adapt/change the parameters of the charging or discharging being applied/provided by the EVSE to the connected EV. In some cases the EV battery may be essentially used as an electricity storing units for use by a residential electric circuit/grid, such that the EVSE may use the electricity stored at a previous time (or location, e.g., at the office) by discharging the EV battery to supply the grid (e.g., residential electric circuit). This may be particularly useful to meet the electricity needs of the household during peak power consumption and/or to reduce the electricity bill by discharging the EV battery when electricity rates are at their highest (and, optionally, charging the EV battery at their lowest rates).

Note that the intelligent/adaptative charging is optional, such that the charging provided by the EVSE may also be any state-of-the-art charging (e.g., the following the charging requirements/request from the connected EV).

When no match is found, an intervention step 28 may be completed according to any suitable intervention protocol (e.g., chosen by the EVSE owner 302).

In some cases, the requesting of an intervention can comprise a step of communicating with an external device 301 to send an intervention request (e.g., requesting of owner inputs via his interface—would you like to allow/add this new vehicle to your list?—, sending alert messages, activating a security or alarm system, etc.). The intervention step 28 may be completed by a management system (e.g., a local management program or a management service provided by an EVSE network and/or external network), e.g., in response to an intervention request.

In some cases, the EVSE 100 can hold off on initiating any charging protocol until the intervention request is satisfied (e.g., once the charger or EV owner send directives).

In some cases, step 28 can further limit the charging/discharging of the connected EV (i.e., prevent a charging protocol to be enabled or initiated before sending the intervention request or while awaiting an intervention response/directive) or can be entirely replaced/by-pass the intervention step (e.g., if the charger owner previously indicates his preference to do so).

An intervention request may be sent to an external device 301, such as a computing device and/or to a personal device (e.g., smartphone), which may be accessible or used by an instruction provider (e.g., a system manager, a user or the owner of the EVSE). The intervention request may be processed by the instruction provider's device (external device 301) and used to query the instruction provider in order to receive confirmations (e.g., validate that the acquired/gathered distinguishing information 111 is accurate), additional or complementary information (e.g., request an EV owner or EV user name or the usage habits of the EV users), and/or instructions (e.g., the EV owner's preferences regarding the type of charging or of charging protocol).

In some embodiments, the EVSE 100 can simply prevent any charging of the EV 200 or the EVSE 100 may limit charging to a select mode such as “low” AC charging only (i.e., preventing fast DC charging).

In some embodiments, the main payload of the intervention request may comprise or may be accompanied by metadata or any additional data packet (e.g., further payload). Additional data packets can comprise instructions for initiating a notification or alarm on the instruction provider's device and may also request authentication of the instruction provider's identity (e.g., identifying passwords or biometrics).

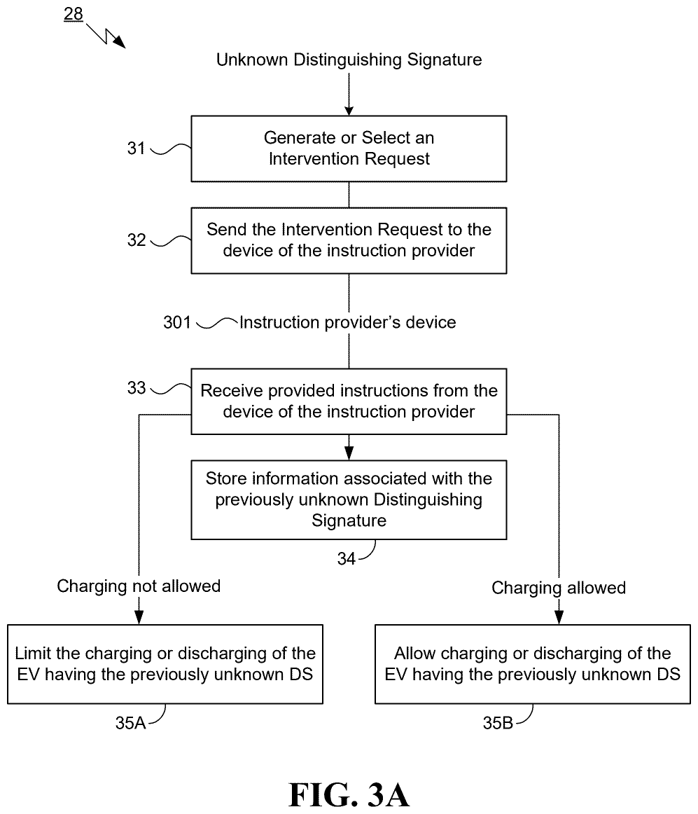

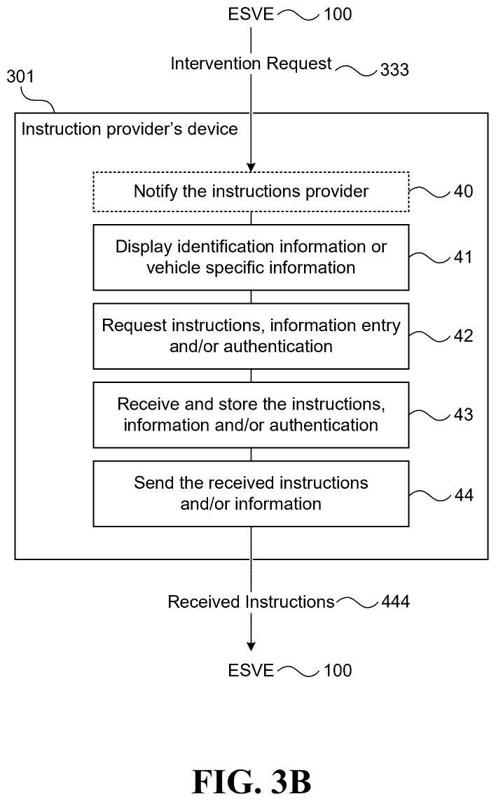

FIG. 3A shows a block diagram of the various steps (or sub-steps) that can be executed as part of the intervention step 28 of the method 20 of accurately and reliably distinguishing an EV connected to the EVSE 100. As such, step 28 may be completed in response to identifying a new (i.e., not present in the list of known distinguishing signatures stored in the database of the EVSE 100) in order to request an intervention, receive instructions and follow the instructions.

In some embodiments, step 28 can comprise a sub-step 31 of generating or selecting an intervention request, a sub-step 32 of sending the intervention request, a sub-step 33, a sub-step 34 of receiving the instructions, a sub-step 34 of storing information, and a step 35 of applying a charging protocol according to the received instructions.

In sub-step 31, the interaction request may be selected from a list of predefined requests, which may be stored in memory accessible by the EVSE 100, may be generated by the EVSE 100 itself or a combination thereof. In sub-step 32, the intervention request can then be displayed on any interface of the EVSE and/or can be sent to any suitable external 301 (e.g., instruction provider's personal device) device for the instruction provider's attention allowing to communicate information any instruction providers and to receive their input (e.g., their instructions).

In some embodiments, the interactions request may comprise vehicle-specific information (e.g., comprised in or derived from the distinguishing information 111) and queries about various fields (e.g., vehicle-specific details). For example, the vehicle-specific information can include, but may not be limited to, the country of origin, the manufacturer, the brand, the engine size, the vehicle type, the model year, where the vehicle was assembled, and the serial number of the vehicle or a combination thereof, which may be useful for the instruction provider to recognize the vehicle in question. For example, the queries comprised in the intervention request can include, but may not be limited to, confirmation requests (e.g., asking to validate that the displayed/identified vehicle-specific information is accurate) or correction requests asking for any required correction (e.g., manually replacing or selecting from a list) inaccurate information, request for charging protocol preferences, authentication request, queries about the default charging protocol upon connection of the specific vehicle, queries about the allowing or chaired management/control of the charging protocol, or a combination thereof.

Once the instructions and complementary information are provided by the instruction provider to the instruction provider's device 301 (or on any user interface of the EVSE) they can then be considered by the EVSE 100 as part of sub-step 33.

In some embodiments, the sub-step 34 of storing information can comprise storing the instruction request, the received instructions, the previous unknown DS in the list of known DS as a new known DS, storing any information derived from the received instructions (e.g., identifying information/characteristics of the EV 200 or any charging protocol preferences associated with the new DS), or a combination thereof. The stored information may be saved in any suitable memory accessible by the EVSE 100, such as the memory 101 of the EVSE 100.

The sub-step 35 may comprise applying any suitable or selected (e.g., as instructed by the received instructions provided by the instruction provider) charging protocol, which can be anything between disable any connection with the connected EV 200 or any charging/discharging of the EV, and allowing any charging requested by the EV 200 or by instruction providers (e.g., the EV owner or the EVSE owner).

In some embodiments, sub-step 35 can be essentially divided into two possible alternatives: sub-step 35A of applying a protocol when the charging is not allowed; and sub-step 35B of applying another protocol when the charging is allowed.

In some embodiments, when the charging of the EV 200 is not allowed by the EVSE 100 (e.g., when the EV does not match any known DS), step 35A can comprise limiting the charging or discharging of the EV 200 new DS (previously unknown and now a known DS being identified/characterized by the instruction provider). It will be appreciated that the action of “limiting” the charging or discharging may include the narrower case of “preventing” any charging or discharging.

In some embodiments, when the charging of the EV 200 is allowed by the EVSE 100, step 35B can comprise providing charging or discharging of the EV 200 according to chosen/selected/defined charging protocol based on the provided instructions (e.g., charging protocol preferences) and therefore based on the new known DS.

It will be appreciated that the various parameters and control parameters of any of the charging protocol may be associated with one or more of the known Ds (or used as a default protocol for unknown DS) and may be selected or modified by any authorized user. The charging protocol may depend on any parameters known in the art (e.g., the charging/discharging capacity of the charger or the battery, habits of usage or charging of the EV, the environmental conditions, the electricity rates, the consumption needs of the household, the number of EVs being charged simultaneously, or more).

In some embodiments, the EVSE 100 may be managed/configured by any authorized user via any suitable platform (e.g., integrated interface of the EVSE or any external device, such as a computer, a smartphone, a tablet, etc.) having sufficient processing power and enabling the authorized user to provide proper inputs (e.g., providing directives or control settings).

FIG. 3B shows a block diagram of one embodiment of the steps that may be completed by the instruction provider's device (external device 301) in order to acquire the instructions and information to fulfill the requested intervention.

It will be appreciated that these steps, although here illustrated as being executed by an external device, in some embodiments, the EVSE can itself comprise a display and/or user interface (e.g., touch screen), which may be part of its communication interface 106.

The intervention request, which may be sent from the EVSE to the external device, here shown as an embodiment where it is an instruction provider's device 301. The instruction provider's device 301 can receive the intervention request 333 and can send any received instructions 444.

To obtain the instructions, after receiving the intervention request, the instruction provider's device 301 may execute an optional step 40 communicate any notification (e.g., tactile, visual or audible signal/alert) and/or communicating the intervention request and associated queries to the instruction provider with its user interface (e.g., display or touch screen).

In some embodiments, to communicate the intervention request, the instruction provider's device 301 can execute a step 41 of communicating (e.g., display) vehicle- specific information or identification information of the unknown DS and a step 42 of questing instruction entries (e.g., providing various options for the various parameters or fields of a charging/discharging protocol for the “new” EV and asking the instruction provider to select the preferred charging parameters) or information entry or a request for authentication (e.g., username, password/code or biometrics) of the user of the device 301 to confirm that he is an authorized instruction provider.

In some embodiments, the intervention request may include queries about the accuracy of the acquired distinguishing information 111. For example, the intervention request may include a confirmation request for the instruction provider to confirm that the communicated (e.g., displayed) vehicle-specific information or the communicated identification information is accurate or inaccurate. The information to be confirmed can comprise one or more educated guess about any useful vehicle's characteristics (e.g., make, model, battery size, wear, etc.), where the educated guess can be based on the acquired distinguishing information 111. When some information is identified as being inaccurate, a further request may be submitted requiring the instruction provider to select the accurate information out of a drop-down list comprising all possible options for the given information field.

In one embodiment, the educated guess about the EV's specifications (e.g., vehicle-specific details such as its make and model) may be determined or extrapolated using some of a collected plurality of distinguishing information 111. For example, the information about the battery charge capacity (e.g., battery “size”) may be used to make an educated guess about the EV's make and model or can at least be used to narrow the possibilities of which is the actual EV's make and model. In some embodiments, this educated guess can be determined or extrapolated using a combination of collected protocol fields data (e.g., any suitable CHAdeMo or DINspec fields) such that the combination of data is known (e.g., from a list or database) to only be found in one or a subset of EV's make and model or EVs having given vehicle-specific details. Once determined (e.g., accurately guessed), the EV's make and model can also be used to determine further vehicle-specific details associated therewith.

It will be appreciated that such confirmation request may be particularly useful over simple information requests (e.g., simple sequence of empty fields to be manually completed/filled by the instruction provider) to the instruction provider (e.g., user). In fact, since the proposed confirmation request may instead present the user with the corresponding educated guess for each field, the user experience can be significantly improved by facilitating and expediting the providing of instructions (e.g., when defining/completing a new “known EV profile”) since it may merely require the user to confirm that the displayed/provided educated guess are accurate and/or would only have to interact (e.g., to select the right information out of a drop-down list) with the few fields where the information is inaccurate.

Once the instruction provider answers the intervention requests, the instruction provider's device 301 can execute step 43 and thereby receive, monitor or record any entry corresponding to each request or query. The recorded entries can be considered as the received instructions 444 or may be used to generate data considered as the received instructions 444.

The step 44 of sending the received or generated instruction 444 back to the EVSE 100 (or to the memory or processor of the EVSE, when the intervention request a communicated and the instructions are received through a user interface of the EVSE).

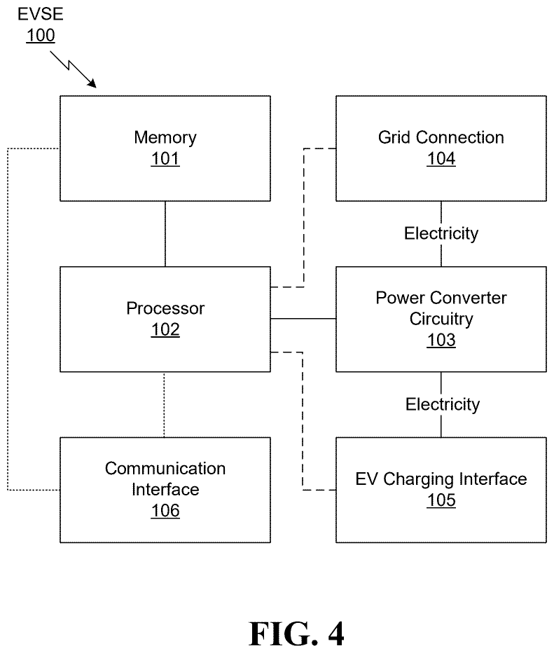

Now referring to FIG. 4 that illustrates a block diagram of various possible hardware components that may be used to achieve or manufacture one embodiment of the proposed EVSE 100. In the illustrated embodiment, the EVSE 100 can comprise a memory 101, a processor 102 and a power converter circuitry 103 for converting electricity to/from a grid connection 104 from/to a charging interface 105 (e.g., an EV connector port for connection to a charging port of the EV or a wireless charging device such as a charging pad, for example) for charging or discharging the EV 200.

Note that the grid connection 104 can be connected directly or indirectly (e.g., via a local house circuitry) to a power grid (i.e., electricity provider/input).

In some embodiments, the EVSE 100 may further comprise a communication interface 106 to perform one or more of the previously mentioned communicating (to communicate with the EV 200, with a user or instruction provider, with a user interface, with an instruction provider's device, with any external device 301, etc.). The communication interface 106 may rely on various communication means (electric wires, internet, ethernet, Wi-Fi, Bluetooth©, mobile network, etc., or a combination thereof).

The memory 101 of the EVSE 100 can be any suitable type of memory known in the art (random-access memory (RAM), read-only memory (ROM), solid-state drive (SSD), hard disk drive (HDD), flash memory, etc.), or a combination thereof, and can be used to store operation codes and programs to execute the required steps of at least one embodiment of the proposed method to properly operate the EVSE 100 and/or any other type of information. In some embodiments, the memory 101 can be used to save/store any required data or metadata.

The memory 101 may or may not comprise a plurality of memory units which may or may not be physically located or coupled with the EVSE 100. The memory 101 may be part of or connected, e.g., via the communication interface 106, to an external component/device 301 (the web, an additional computing device, a cloud service, remote server, client's device, etc.).

The various embodiments of the proposed method can be implemented as program code stored in memory 101 so as to be performed by the processor 102.

The EVSE 100 can comprise one or more processor 102, which may be any suitable general-purpose programmable hardware (central processing unit, microprocessor, DSP, FPGA, etc.). In FIG. 4, the processor 102 is shown as being unitary, but it may also be multicore, or distributed (e.g., a multiprocessor) in some embodiments.

The processor 102 may be connected to and exchange data with the memory 101. The processor 102 can receive and execute instructions from the memory 101 and may receive data (e.g., charge messages comprising distinguishing information 111 and, optionally, a unique EV ID.) from the EV 200 (e.g., via its charging interface 105 when it is a charging cable or via its communication interface 106 when the charging interface 105 is a wireless charger). The processor 102 can process and store the received data as per any embodiments of the proposed method.

It will be appreciated that the power converter circuitry 103 can be any suitable circuitry known in the art that can be used to ensure that the electric power provided by the EVSE 100 is receivable by or suitable for the EV 200.

In some embodiments, the power converter circuitry 103 can receive an alternative current (AC) and/or a direct current (DC) and can convert it to AC or DC.

Some embodiments of the EC charger 100 are a two-way charger that can both charge and discharge the EV 200 to, respectively, consume and feed electric power from and to the grid connection 104. In such embodiments, the power converter circuitry 103 can be a back-to-back power converter (e.g., as proposed in the international publication WO 2019/071359).

Some embodiments of the power converter circuitry 103 can comprise a circuitry controller (e.g., switch controller) which may be implemented in the processor 102 (e.g., using a database or various exhaustive lookup table for the control signals) or in hardware (e.g., logic gate circuitry and/or Field Programmable Gate Array (FPGA)) as part of the power converter circuitry 103. The switch controller may be used to drive various switches of the power converter circuitry 103 (e.g., by generating or selecting from a database, based on the reference signal and a desired signal output, a desired switching signal that may use one or more switching signal method known in the art, such as random pulse width modulation, for example) and/or to receive and use a reference signal (e.g., the electric signal from the grid connection 104) to ensure the converted power sent to the EV, through the EV charging interface 105, respects the various requirements to enable the desired charging of the EV. It will be appreciated that the processor may be connected to the grid connection 104 in order to measure/monitor the electric current of the grid (e.g., a reference signal for the power conversion and for generating the switching signals), which may be necessary when the circuitry controller is performed by or integrated in the processor 102.

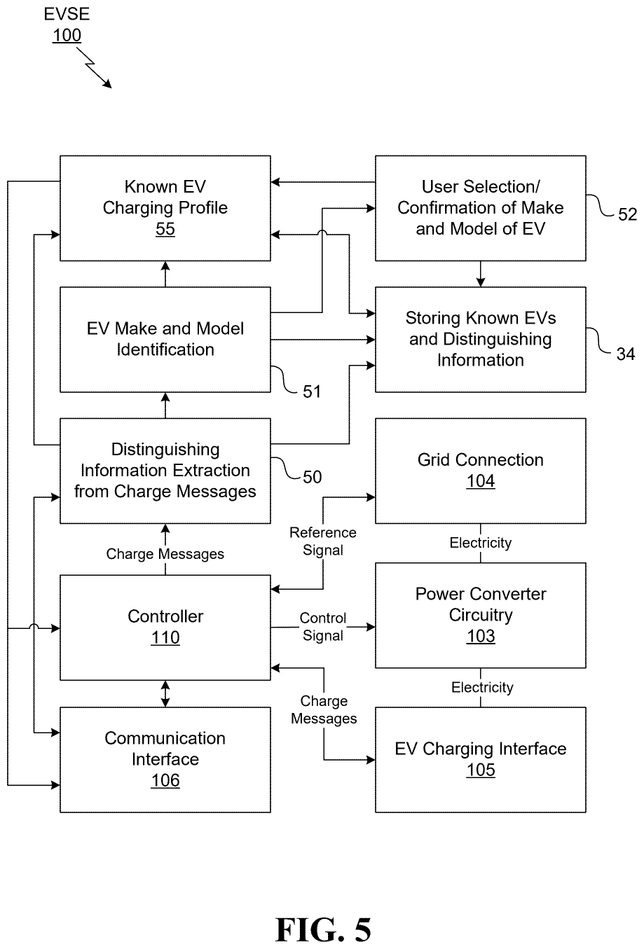

Now referring to the block diagram of FIG. 5 where data (e.g., charge messages) from the EV is received by the EV charging interface 105 (or by the communication interface 106, for example, when the charging interface is a wireless charging pad) is transferred to the controller 110 (e.g., processor or circuitry/FPGA). A step 50 of extracting distinguishing information 111 from the received data (e.g., received charge messages) or generating/defining a distinguishing signature, which may be completed by the controller 110 in some embodiments. It will be appreciated that the controller 110 may be used for various purposes, such as data processing, exchanging data/instructions (e.g., communications, distinguishing information 111, make on models, reference signal from the grid, etc.), generating control signals (e.g., for controlling the various components of the EVSE 100), generating/sending switching signals for the power switches of the power converter 103, etc. In one embodiment, the controller can comprise the processor 102.

A step 34 of storing (e.g., in a corresponding database) the extracted/acquired distinguishing information 111 may be completed and/or can be used to distinguish or identify an EV as corresponding to a known EV charging profile 55 (e.g., charging history or EV-specific charging protocol(s) or authentication data or EV owner information). In one embodiment, step 34 can comprise storing the information in the memory 101 of the EVSE 100. The charging profile 55 of a known EV can be used to store various information (hardware information, make and model, etc.) or complementary data about the EV (owner's name, charging habits, usage habits, etc.) or any information/data mentioned herein that can be associated with a given EV.

In some embodiments, the EV may provide the EVSE with a unique EV ID. In such cases, while it may no longer be necessary to identify the connected EV, the distinguishing information 111 may still be used for correspondence with the known EV charging profile 55 and/or may be used for determining/identifying the make and model of the connected EV (step 51). In these cases, the determined make and model of the connected EV may be particularly useful to improve the user experience, for example, by providing the instruction provider (e.g., user) with a prefilled EV profile (e.g., when sending the intervention request) that may only require the instruction provider to complete a step 52 of confirm that the prefilled profile information (e.g., the make and model fields being filled with the educated guess based on the distinguishing information 111) is accurate and/or, if necessary, to input/provide and preferably select from a drop-down list (a list comprising a narrowed down number of the possible choices-e.g., make and models-, wherein the narrowing down is based on the extracted distinguishing information 111), the accurate/actual information.

It will be appreciated that the step 52 may complete the communication interface 106 and the instruction provider's device 301 (e.g., using the method of FIG. 3A). In some embodiments, step 52 may be one of the possible embodiments of the previously mentioned confirmation requests.

In some embodiments, step 34 can comprise storing the make and model of the EV after step 52 is completed: once it has been confirmed and/or selected by the instruction provider (e.g., user).

The known EV charging profile 55, which may comprise the charging protocol of a given EV, can be adjusted or defined using the make and model whether it has been identified (results from step 51) or it has been confirmed/selected by the user (results from step 52). The known EV charging profile 55 can be stored in or retrieved from memory 101.

The charging protocol of a known EV charging profile 55 may be provided to the controller 110 thereby enabling an EV-specific charging (e.g., optimized or enhanced charging) of the known connected EV by controlling the power converter circuitry 103.

The charging protocol of a known EV charging profile 55 may be provided to the communication interface 106 and can be transmitted to any external device 301.

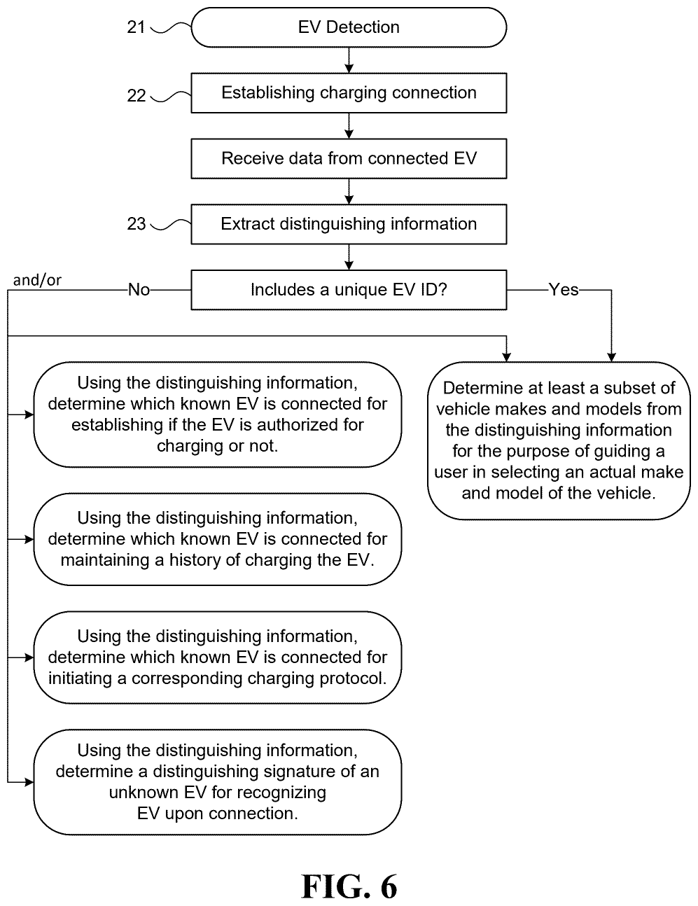

FIG. 6 presents a flow chart of some of the possible main steps of an embodiment of the proposed method. Some embodiments, the method can comprise a step 21 of detecting the presence of an EV, a step 22 of establishing a charging connection or charging session between the EVSE 100 and the detected EV 200 (known or unknown), a step of exchanging data or pieces of information (e.g., charging messages) between the connected EV 200 and the EVSE 100, and a step 23 of extracting the distinguishing information 111 from data received from the EV.

This embodiment of the proposed method may be completed by a controller 110 or a processor 102, which may result from the executing instructions or program code that may be stored in a local or remote memory 101. It will be appreciated that, while these hardware components may be part of some embodiments of any EVSE (e.g., the proposed EVSEs or any suitable EVSE known in the art as the person with ordinary skill in the art would know how to implement it in), the controller 110, processor 102, memory 101 and/or the communication interface may be part of any suitable device (e.g., a remote device 301, a cloud service, smartphone, a network manager, a data center, a personal computer, an intelligent home management unit, etc.) and does not have to be included in an EV charger, an EVSE 100 or a power converter 103.

The extracted distinguishing information 111 may be used for various purposes, which may depend on the whether or not the received data or the extracted distinguishing information 111 comprised a unique EV ID (e.g., NIV or MAC address) of the connected EV.

Optionally, a step of determining whether or not a unique EV ID is present (has been provided or will be provided by the EV) may be completed.

In some of the embodiments, when the unique EV ID is present or absent, the method may be used for determining at least a subset of the vehicle makes and models (e.g., an educated guess of the makes and models) of the connected EV from, using, or based on the extracted distinguishing information 111. It will be appreciated that determining the makes and models may be for the purpose of guiding a user in selecting/confirming an actual make and model of the vehicle (e.g., when creating a new known EV charging profile), thereby providing a significantly improved user experience or facilitating the work of an instruction provider.

Alternatively or complementarily, in some embodiments, when the unique EV ID is absent (i.e., not provided by the connected EV), the method may enable the use of the extracted distinguishing information 111 for determining or generating a distinguishing signature specific to an unknown EV. It will be appreciated that the distinguishing signature may later be used for recognizing or identifying the corresponding EV or an associated EV charging profile or an EV-specific charging protocol, thereby improving the services provided by the EVSE, for example.

Alternatively or complementarily, in some embodiments, when the unique EV ID is absent (i.e., not provided by the connected EV), the method may enable the use of the extracted distinguishing information 111 for determining (e.g., recognize or identify) which EV is connected upon connection for establishing if the EV is authorized for charging or not, for maintaining/updating a history of charging the EV, for initiating an EV-specific charging, or a combination thereof.

It will be appreciated that it may be significantly advantageous to determine whether or not a given EV 200 is authorized for charging on a given EVSE 100, since it may provide increase protection/security against possible energy/electricity thefts. For example, the charging profile 55 of a distinguished/recognized/identified connected EV may indicate is that particular EV is allowed to be connected or to use the EVSE 100. Note that, in some cases, the charging of the connected vehicle may not be affected by this determining step, such that the unauthorized EV may still be able to be charged. However, it will be appreciated that a record of connections or charging events may be updated accordingly, by indicated that an authorized or unauthorized EV has connected or used the EVSE at a given moment (e.g., time of day and level of electricity consumed). In some embodiments, when an unauthorized EV is detected, various communications signals (e.g., send alert messages any suitable person (e.g., EVSE owner, homeowner, security guard, police, etc.) may be sent or any security/alarm system (integrated to the EV charger or of the home)) may be triggered.

It will be appreciated that it may be significantly advantageous to determine whether or not a given EV is authorized for maintaining/updating a history of charging the EV since it can provide a detailed record of the EV and EV battery usage and/or wear. In fact, some embodiments of the history of charging of any known EV may be used to monitor and possibly detect any reduction in performance or potential important wear of the EVSE or of the EV (e.g., EV battery).

For example, if a decrease in charging performance is identified using the history of charging it may be attributed to the EV if the decrease in absent for other EVs or may be attributed to the EVSE if the decrease is present for all EVs. The system, and potentially an AI-based/shared analysis algorithms may be used to identify any required maintenance of the EVSE, the EV or both. In fact, if trained on sufficient historical data (e.g., charging history and data about the defect that historically corresponds to a given change in charging) preventive detection of required maintenance may be integrated to the EVSE or provided separately (e.g., at a data center in communication). This may be especially advantageous for owners of medium to large fleet of EVs, which may be associated to a business model depend on the good functioning of that fleet of EVs.

It will be appreciated that it may be significantly advantageous for initiating/applying an EV-specific charging protocol (e.g., enhanced charging) corresponding to the recognized EV. It will be appreciated that, when the recognized EV in an unauthorized EV, the EV-specific charging protocol may simply limit or prevent any further interaction between the EVSE and the connected EV (e.g., end the established connection or prevent both charging and discharging) or prevent only some features (e.g., allow the discharging of the connected EV, while preventing any charging).

What is claimed is:

1. An electric vehicle supply equipment (EVSE) for distinguishing an EV connected to said EVSE, the device comprising:
an EV charging interface for charging said EV;
a communication interface for receiving messages from said EV;
power converter circuitry;
a processor; and
memory storing program code that, when executed by said processor, causes said processor to:
a) establish a connection with said EV once said EV charging interface is connected to said EV;
b) receive a plurality of said messages from said EV:
c) select distinguishing information from said plurality of messages; and
d) determine at least one of:
1. which known EV is connected using the selected distinguishing information in the absence of a unique EV identifier (ID) being provided for the purposes of at least one of:
i. establishing if the EV is authorized for charging;
ii. maintaining a history of charging the EV; and
iii. initiating a charging protocol associated with said determined known EV;
2. at least a subset of vehicle makes and models from said distinguishing information for the purpose of guiding a user in selecting or confirming an actual make and model of the vehicle; and
3. a distinguishing signature of an unknown EV using the selected distinguishing information in the absence of a unique EV identifier (ID) being provided for the purpose of recognizing said unknown EV when a next connection is established between the EVSE.

2. The EVSE as defined in claim 1, wherein said determining comprises, in the absence of said unique EV ID, said determining of which of said known EV is connected using the selected distinguishing information for the purposes of said establishing if the EV is authorized for charging.

3. The EVSE as defined in claim 1, wherein said determining comprises, in the absence of said unique EV ID, said determining of which of said known EV is connected using the selected distinguishing information for the purposes of said maintaining said history of charging the EV.

4. The EVSE as defined in claim 1, wherein said determining comprises, in the absence of said unique EV ID, said determining of which of said known EV is connected using the selected distinguishing information for the purposes of said initiating said charging protocol of associate with said determined known EV.

5. The EVSE as defined in claim 1, wherein said messages from said EV comprises said unique EV ID, wherein said program code, when executed by said processor, further causes said processor to identify said EV using said unique EV ID, and wherein said distinguishing information, and wherein said subset of vehicle makes and models are identified from said distinguishing information for said guiding of said user in said selecting said actual make and model of the vehicle.

6. The EVSE as defined in claim 5, wherein said unique EV ID a media access control (MAC) address of said EV or a vehicle identification number (VIN).

7. The EVSE as defined in claim 1, wherein said determining comprises, in the absence of said unique EV ID, said determining of said distinguishing signature of said unknown EV using the selected distinguishing information for the purpose of recognizing said unknown EV when a next connection is established between the EVSE, thereby allowing for an initiating of a corresponding history of charging, for initiating of a corresponding charging protocol, or for establishing charging is authorized.

8. The EVSE as defined in claim 7, wherein said determining further comprises defining parameters of said corresponding charging protocol based on charging directives from an instruction provider.

9. The EVSE as defined in claim 8, wherein said parameters of said corresponding charging protocol are provided in response to an intervention request requesting said charging directives, wherein said communication interface sends said intervention request to a personal device of said instruction provider, and wherein said charging directives from said instruction provider are received by said communication interface.

10. The EVSE as defined in claim 9, wherein said intervention request further comprises:
educated guesses about the EV characteristics based on said distinguishing information, and
a request for the instruction provider to validate said educated guesses or to correct said educated guesses by indicating an actual information.

11. The EVSE as defined in claim 10, wherein said EV characteristics comprise makes and models of said known EV.

12. The EVSE as defined in claim 1, wherein said EV charging interface and said communication interface are comprised in a charging connector of said EVSE.

13. The EVSE as defined in claim 1, wherein said charging connector comprises a CHAdeMO plug for connecting to a CHAdeMO socket of said EV, wherein said charging protocol is a CHAdeMO protocol, and wherein said at least one distinguishing information and said various distinguishing information comprise CHAdeMO fields.

14. The EVSE as defined in claim 1, wherein said collection of data from said various distinguishing information comprises a hash value.

15. The EVSE as defined in claim 1, wherein said collection of data from said various distinguishing information comprises a Boolean value.

16. The EVSE as defined in claim 1, wherein said power converter circuitry is a bidirectional power converter circuitry, and wherein said charging protocol allows for both said charging and said discharging of said EV.

17. The EVSE as defined in claim 8, wherein, if said EV is an unknown EV, said program code, when executed by said processor, further causes said processor to limit said charging or said discharging of said unknown EV until said parameters of said corresponding charging protocol defined.

18. The EVSE as defined in claim 16, wherein said limiting of said charging protocol comprises preventing any said charging or said discharging of said unknown EV.

19. The EVSE as defined in claim 1, wherein said program code, when executed by the processor, further causes said processor to detect a presence of said EV near said EVSE.

20. The EVSE as defined in claim 8, wherein, said program code, when executed by said processor, further causes said processor to save said determined distinguishing signature in a collection of known distinguishing signatures as a known distinguishing signature.
